(19) United States
(12) Patent Application Publication
(10) Pub. No.: US 2008/0106845 A1
(43) Pub. Date: May 8, 2008

(54) Capacitor and Method for Producing the Same

(76) Inventors: Hiroshi Kunimatsu, Moriyama-shi (JP); Yoshinori Oyabu, Kyoto-shi (JP); Tadahiro Minamikawa, Ritto-shi (JP); Atsuyoshi Maeda, Otsu-shi (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 12/014,180

(22) Filed: Jan. 15, 2008

Related U.S. Application Data
(63) Continuation of application No. PCT/JP2006/313646, filed on Jul. 10, 2006.

(30) Foreign Application Priority Data
Jul. 15, 2005 (JP) JP 2005-206941
Oct. 18, 2005 (JP) JP 2005-303142

(51) Int. Cl. H01G 4/005

(52) U.S. Cl. 361/303

(57) ABSTRACT

A low-profile capacitor that can be bent and that has excellent interlayer adhesion strength. The capacitor includes a dielectric layer, a first capacitor electrode formed on a first main surface of the dielectric layer, a second capacitor electrode formed on a second main surface of the dielectric layer, and a lead electrode formed on the first main surface of the dielectric layer and electrically connected to the second capacitor electrode. The dielectric layer has a thickness of 5 μm or less. The sum of the thicknesses of the first and second capacitor electrodes is 5 μm or more and at least twice the thickness of the dielectric layer. The first and second capacitor electrodes and the lead electrode are formed of a malleable metal. The dielectric layer and the first and second capacitor electrodes are formed by being simultaneously sintered.

### CROSS REFERENCE TO RELATED APPLICATIONS

The present application is a continuation of International Application No. PCT/JP2006/313646, filed Jul. 10, 2006, which claims priority to Japanese Patent Application No. JP2005-206941, filed Jul. 15, 2005, and Japanese Patent Application No. JP2005-303142, filed Oct. 18, 2005, the entire contents of each of these applications being incorporated herein by reference in their entirety.

### FIELD OF THE INVENTION

The present invention relates to capacitors and methods for producing the capacitors.

### BACKGROUND OF THE INVENTION

Capacitors, one type of electronic component used in electronic devices, have been decreasing in size with the recent trend for size reduction of electronic devices. In the field of monolithic ceramic capacitors, for example, products with small mounting areas such as the 0603 size (mounting area: 0.6 mm×0.3 mm) and the 1005 size (mounting area: 1.0 mm×0.5 mm) are becoming mainstream in markets where size reduction is highly demanded, including communications devices.

In addition to a smaller mounting area, a lower component profile has recently been demanded. Strict dimensional constraints have been imposed not only on the area but also on the thickness direction because a cellular phone, for example, must incorporate a mounting substrate in an extremely limited space.

It is difficult, however, to reduce the thickness of a monolithic ceramic capacitor to, for example, 50 μm or less in terms of mechanical strength because the dielectric ceramic used in the capacitor, which includes internal electrode layers and dielectric ceramic layers stacked on top of each other, is relatively brittle. Because the dielectric ceramic is relatively brittle and its thickness accounts for at least half the thickness of the monolithic ceramic capacitor, the capacitor cannot provide sufficient mechanical strength and is therefore difficult to handle if its thickness is reduced to 50 μm or less.

In addition, flexible substrates have increasingly been used as mounting substrates that can be bent, and accordingly capacitors that can be mounted on such substrates have also been demanded.

Patent Document 1 discusses an example of a ceramic capacitor having a structure suitable for a lower profile. This ceramic capacitor includes capacitor electrodes formed on two surfaces of a ceramic substrate and a lead electrode formed on the same surface as one of the capacitor electrodes and electrically connected to the other capacitor electrode. This capacitor can achieve a lower profile than a monolithic capacitor because it does not include many dielectric layers, unlike a monolithic capacitor.

Another example of the prior art is a ceramic capacitor discussed in Patent Document 2. This ceramic capacitor includes a dense sintered ceramic layer with a thickness of 1 to 10 μm and porous sintered ceramic layers formed on two surfaces thereof, with terminal electrodes formed by impregnating the porous sintered ceramic layers with metal. According to this invention, the capacitor can have a sufficient total mechanical strength even if the dense sintered ceramic layer is extremely thin.

Patent Document 3 discusses an example of a prior-art capacitor with low profile and certain flexibility. This capacitor includes a dielectric formed on a smooth surface of a metal foil and a conductive layer formed on the dielectric.

Patent Document 1: Japanese Unexamined Patent Application Publication No. 7-111226

Patent Document 2: Japanese Unexamined Patent Application Publication No. 4-233711

Patent Document 3: Japanese Unexamined Patent Application Publication No. 2005-39282 (particularly, Paragraphs 0063 to 0066 and FIG. 11)

The ceramic capacitor discussed in Patent Document 1 depends for its total mechanical strength on the ceramic substrate. The thickness reduction of the ceramic substrate is limited because the dielectric ceramic is relatively brittle, as described above. This leads to limited profile reduction and also makes it difficult to achieve high capacitance because the distance between the capacitor electrodes is difficult to reduce. In addition, it is difficult to mount the capacitor on a flexible substrate because a typical ceramic substrate cannot be bent.

The ceramic capacitor discussed in Patent Document 2 cannot be bent and is therefore difficult to mount on a flexible substrate because the terminal electrodes are formed by impregnating the porous ceramic with metal. In addition, because the terminal electrodes are formed by impregnating the porous ceramic with metal, it is difficult to define a constant distance between the terminal electrodes facing each other with the dense sintered ceramic layer disposed therebetween. This causes an electric field to concentrate in a region where the distance is smaller, thus increasing leakage current and decreasing withstand voltage. Another difficulty lies in the patterning of the terminal electrodes because they are formed by impregnating the porous ceramic with metal.

The capacitor discussed in Patent Document 3 has certain flexibility because of the malleability of the metal foil and can be formed with low profile. It is difficult, however, to increase the adhesion between the metal foil and the dielectric because the dielectric is formed on the smooth surface of the metal foil. If the capacitor is used by being embedded in a resin substrate, the metal foil and the dielectric may be delaminated by a stress exerted by the resin substrate. The metal foil and the dielectric may also be delaminated under use conditions other than the embedding in the resin substrate, for example, if a stress is exerted by a semiconductor component mounted on the capacitor.

### SUMMARY OF THE INVENTION

An object of the present invention, which has been made to solve the above problems, is to provide a low-profile capacitor that can be bent and that has excellent interlayer adhesion strength.

To solve the above problems, a capacitor according to a preferred embodiment of the present invention includes a dielectric layer, a first capacitor electrode formed on a first main surface of the dielectric layer, a second capacitor electrode formed on a second main surface of the dielectric layer, and a lead electrode formed on the first main surface of the dielectric layer and electrically connected to the second capacitor electrode. The dielectric layer has a thickness of 5 μm or less. The sum of the thicknesses of the first and second capacitor electrodes is 5 μm or more and at least twice the thickness of the dielectric layer. The first and second capacitor electrodes and the lead electrode are formed of a malleable metal. The dielectric layer and the first and second capacitor electrodes are formed by being simultaneously sintered.

If the sum of the thicknesses of the first and second capacitor electrodes is larger than the thickness of the dielectric layer so that the first and second capacitor electrodes can provide sufficient mechanical strength for the capacitor, the thickness of the dielectric layer can be reduced to achieve a lower profile and a higher capacitance. In addition, if the dielectric ceramic, which is a brittle material, is reduced in thickness, it can withstand a certain extent of bending. This allows the capacitor to be bendable, so that it can be mounted on a flexible substrate or a curved surface.

It is desirable that the first and second capacitor electrodes and the lead electrode be formed of a malleable metal. Preferably, these electrodes are formed only of a metal, although they may contain impurities or additives in such amounts as not to impair the malleability of the metal.

In the present invention, if the first and second capacitor electrodes and the dielectric layer are formed by being simultaneously sintered, the capacitor can achieve excellent adhesion between the first and second capacitor electrodes and the dielectric layer.

In the capacitor according to the preferred embodiment of the present invention, if the lead electrode is positioned so that the first capacitor electrode surrounds as large a portion of the periphery of the lead electrode as possible, external connection means (such as a bonding wire, a bump, or a via hole) connected to the lead electrode is surrounded by external connection means connected to the first capacitor electrode. Such an arrangement can reduce inductance because a magnetic field generated by the external connection means connected to the lead electrode cancels out a magnetic field generated by the external connection means connected to the first capacitor electrode.

Specifically, the external connection means connected to the first capacitor electrode can be arranged so as to surround the external connection means connected to the lead electrode for reduced inductance if, for example, the lead electrode is disposed in the center of the first capacitor electrode and is surrounded in its entirety by the first capacitor electrode, if the lead electrode is disposed midway along a side of the dielectric layer and is surrounded by the first capacitor electrode in directions other than a direction in which the lead electrode faces the side, or if the lead electrode is disposed in a corner of the dielectric layer and is surrounded by the first capacitor electrode in a diagonal direction of the corner. The phrase “center of the capacitor electrode” does not means the exact “center”, but merely means a position other than the vicinity of the edges.

A reduction in the equivalent series inductance of capacitors is becoming more important with the recent trend for higher operating frequencies of electronic devices.

In addition, the capacitor preferably includes a plurality of lead electrodes. The plurality of lead electrodes can form separate current paths in the plane of the second capacitor electrode to further reduce the inductance of the capacitor.

A method for producing a capacitor according to a preferred embodiment of the present invention includes the steps of preparing a dielectric green sheet containing a dielectric powder and a binder and having a through-hole and conductor green sheets containing a metal powder and a binder, forming a laminate by laminating the conductor green sheets on two main surfaces of the dielectric green sheet so as to at least partially cover the through-hole and pressing the laminated sheets, and firing the laminate. The capacitor includes a dielectric layer formed by firing the dielectric green sheet, a first conductive layer formed on one main surface of the dielectric layer, and a second conductive layer formed on another main surface of the dielectric layer. The first and second conductive layers are formed by firing the conductor green sheets and are electrically connected together via the through-hole. The dielectric green sheet is formed so that the dielectric layer has a thickness of 5 μm or less. The conductor green sheets are formed so that the sum of the thicknesses of the first and second conductive layers is 5 μm or more and at least twice the thickness of the dielectric layer.

In addition, at least part of the second conductive layer may be a second capacitor electrode, and the method may further include a step of dividing the first conductive layer into a lead electrode electrically connected to the second capacitor electrode via the through-hole and a first capacitor electrode electrically insulated from the second capacitor electrode.

If the dielectric layer is sufficiently thin and the sum of the thicknesses of the first and second capacitor electrodes is sufficiently larger than the thickness of the dielectric layer so that the first and second capacitor electrodes can provide sufficient mechanical strength for the capacitor, the thickness of the dielectric layer can be reduced to achieve a lower profile and a higher capacitance. In addition, if the dielectric ceramic, which is a brittle material, is reduced in thickness, it can withstand a certain extent of bending. This allows the capacitor to be bendable.

In the present invention, the thickness of a dielectric layer indicates the thickness of its thinnest portion, and the thickness of a conductive layer indicates the thickness of its thickest portion.

In the preferred embodiment of the present invention, the conductor green sheets and the dielectric green sheet are laminated and simultaneously sintered, so that the capacitor can achieve excellent adhesion between the first and second capacitor electrodes and the dielectric layer.

In addition, if the first conductive layer is divided by etching, for example, to form the first capacitor electrode and the lead electrode, the capacitor can readily be produced which includes the first capacitor electrode and the lead electrode formed in the same plane. Alternatively, the first conductive layer may be used as the lead electrode with the first capacitor electrode formed separately.

### ADVANTAGES

According to the preferred embodiments of the present invention, as described above, a low-profile capacitor that can be bent and that has excellent interlayer adhesion strength can be produced by simultaneously sintering a dielectric layer and first and second capacitor electrodes thicker than the dielectric layer.

### BRIEF DESCRIPTION OF THE DRAWINGS

FIG. 1 shows a plan view and a sectional view of a capacitor according to a first embodiment of the present invention.

FIG. 2 shows sectional views illustrating a process of producing the capacitor according to the first embodiment of the present invention.

FIG. 3 shows a plan view and a sectional view of a capacitor according to a second embodiment of the present invention.

FIG. 4 shows a plan view and a sectional view of a capacitor according to a third embodiment of the present invention.

FIG. 5 shows a plan view and a sectional view of a capacitor according to a fourth embodiment of the present invention.

### DETAILED DESCRIPTION OF THE INVENTION

Preferred embodiments of the present invention will now be described with reference to the accompanying drawings.

### First Embodiment

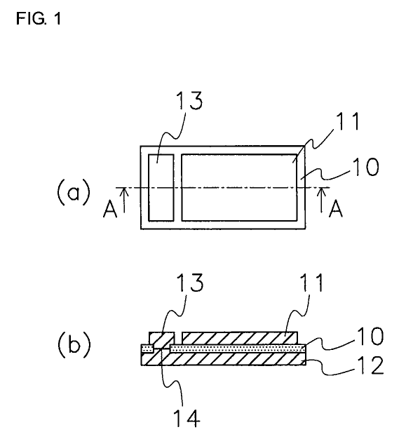

FIG. 1(a) is a plan view of a capacitor according to a first embodiment of the present invention, and FIG. 1(b) is a sectional view taken along line A-A of FIG. 1(a). The capacitor of the invention includes a dielectric layer 10, a first capacitor electrode 11 and a lead electrode 13 formed on one main surface of the dielectric layer 10, and a second capacitor electrode 12 formed on the other main surface of the dielectric layer 10. The lead electrode 13 connects to the second capacitor electrode 12 via a through-hole 14 formed in the dielectric layer 10.

The dielectric layer 10 is formed of BaTiO₃, and the capacitor electrodes 11 and 12 and the lead electrode 13 are formed of nickel. The dielectric layer 10, the capacitor electrodes 11 and 12, and the lead electrode 13 are formed by being simultaneously sintered.

The dielectric layer 10 has a thickness of about 1.2 μm. The capacitor electrodes 11 and 12 and the lead electrode 13 each have a thickness of about 7.5 μm. The sum of the thicknesses of the capacitor electrodes 11 and 12 is about 15 μm. This capacitor is flexible and can be bent because the dielectric layer 10 is sufficiently thin.

Next, a method for producing the capacitor of this embodiment will be described in detail.

(1) Step of Preparing Green Sheets

A dielectric ceramic slurry was prepared by mixing and dispersing a dielectric ceramic powder mainly containing BaTiO₃ and having an average particle size of 0.2 μm, a binder mainly containing poly(vinyl butyral), and a solvent containing toluene and ethanol in a volume ratio of 1:1. The dielectric ceramic powder, the binder, and the solvent were mixed in a volume ratio of 10:10:80, where the volume of the dielectric ceramic powder was calculated by measuring the weight of the powder and dividing it by its theoretical density (the same method was used to calculate the volumes of powders described below). The dielectric ceramic slurry was then formed into a dielectric green sheet using a doctor blade. The thickness of the dielectric green sheet was adjusted so that it had a thickness of 1.2 μm after firing.

A conductor slurry was prepared by mixing and dispersing a nickel powder having an average particle size of 0.5 μm, a binder mainly containing poly(vinyl butyral), and a solvent containing toluene and ethanol in a volume ratio of 1:1. The nickel powder, the binder, and the solvent were mixed in a volume ratio of 10:10:80. The conductor slurry was then formed into conductor green sheets using a doctor blade. The thickness of the conductor green sheets was adjusted so that they had a thickness of 7.5 μm after firing.

A firing-supporting ceramic slurry was prepared by mixing and dispersing an Al₂O₃ (alumina) powder having an average particle size of 1.0 μm, prepared as an inorganic oxide material, a binder mainly containing poly(vinyl butyral), and a solvent containing toluene and ethanol in a volume ratio of 1:1. The Al₂O₃ powder, the binder, and the solvent were mixed in a volume ratio of 10:10:80. The firing-supporting ceramic slurry was then formed into firing-supporting green sheets with a thickness of 100 μm using a doctor blade.

(2) Laminating Step

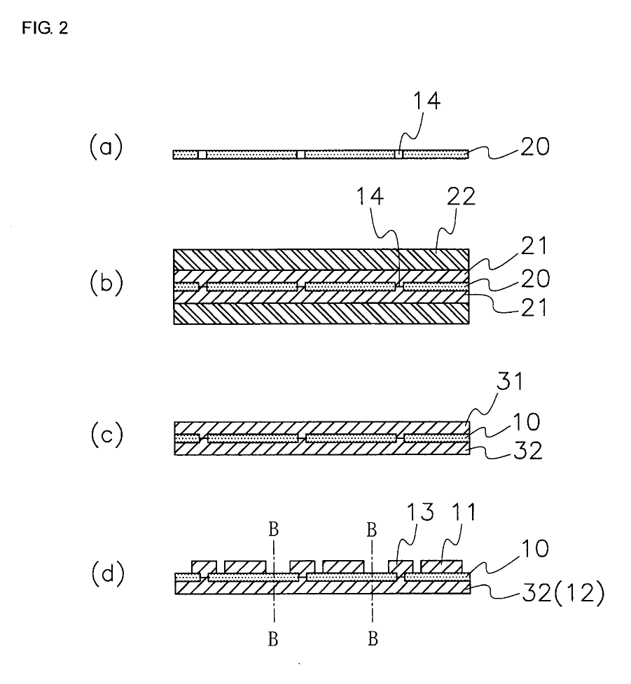

Referring to FIG. 2(a), through-holes 14 with a diameter of 100 μm were formed in a dielectric green sheet 20 by a laser. The dielectric green sheet 20, conductor green sheets 21, and firing-supporting green sheets 22 were laminated as in the positional relationship shown in FIG. 2(b). Specifically, the conductor green sheets 21 were laminated on the two main surfaces of the dielectric green sheet 20 so as to cover the through-holes 14, and the firing-supporting green sheets 22 were laminated on the outer surfaces of the conductor green sheets 21. The laminate was pressed at 50° C. and 200 MPa for 30 seconds, so that the conductor green sheet 21 laminated on one main surface of the dielectric green sheet 20 was connected inside the through-holes 14 to the conductor green sheet 21 laminated on the other main surface. Even if the conductor green sheets 21 are insufficiently connected inside the through-holes 14, they are successfully connected inside the through-holes 14 because their viscosity decreases during a firing step described below.

(3) Firing Step

The laminate thus prepared was degreased by heat treatment at 280° C. in a nitrogen atmosphere for five hours. The laminate was then kept at 1,150° C. in a reducing atmosphere for two hours before the temperature was decreased in a neutral atmosphere. The type of firing atmosphere was determined with respect to the redox equilibrium oxygen partial pressure of nickel; it is referred to as a reducing atmosphere if the oxygen partial pressure falls below the equilibrium and as a neutral atmosphere if the oxygen partial pressure is near the equilibrium.

Referring to FIG. 2(c), a sintered laminate was thus prepared which included the dielectric layer 10 and a first conductive layer 31 and a second conductive layer 32 formed on the two main surfaces of the dielectric layer 10.

The firing-supporting green sheets 22 were spontaneously delaminated from the conductive layers 31 and 32 during the firing. This can be understood as follows.

The metal powder contained in the conductor green sheets and the alumina contained in the firing-supporting green sheets have a relatively large difference in linear thermal expansion coefficient. This results in a difference in the amount of thermal expansion when the temperature in the firing furnace is decreased during the firing step, thus leaving an interfacial stress between the conductor green sheets and the firing-supporting green sheets. During the firing step, additionally, the change in the oxygen partial pressure from the reducing atmosphere to the neutral atmosphere varies the surface oxidation state of the metal powder (nickel powder) contained in the conductor green sheets. This results in a volume change which further increases the interfacial stress between the conductor green sheets and the firing-supporting green sheets.

The spontaneous delamination during the firing can thus be understood as a result of the interfacial stress due to the difference in linear thermal expansion coefficient in combination with the stress due to the variation in the surface oxidation state of the metal powder.

(4) Patterning and Cutting Steps

Next, the first conductive layer 31 was subjected to photoresist application, exposure, and development before being partially removed by wet etching. Referring to FIG. 2(d), the first conductive layer 31 was divided into the first capacitor electrode 11, which was isolated from the second conductive layer 32 (second capacitor electrode 12), and the lead electrode 13, which was connected to the second conductive layer 32 (second capacitor electrode 12) via the through-hole 14. The sintered laminate was cut to a size of 1.0 mm×0.5 mm along cutting lines B, the one-dot chain lines of FIG. 2(d). Thus, the capacitor shown in FIGS. 1(a) and 1(b) was finished.

Capacitors including dielectric layers and first and second conductive layers with various thicknesses were prepared by the same method as described above and were examined for defects such as cracks after they were bent at a radius of curvature of 5 mm. The results are shown in Table 1. The thicknesses of the dielectric layers and the conductive layers were determined by measurements on cross sections obtained by focused ion beam (FIB) processing. The thickness of the thinnest portion of the dielectric layer held between the first and second conductive layers was defined as the “thickness of the dielectric layer”, and the sum of the thicknesses of the thickest portions of the first and second conductive layers was defined as the “thickness of the conductive layers”.

TABLE 1

| | Thickness of | Thickness of | |
|---|---|---|---|
| Sample | dielectric | conductive | |
| No. | layer (μm) | layers (μm) | Evaluation |
| 1 | 1.2 | 15 | Good |
| 2 | 0.5 | 5 | Good |
| 3 | 3 | 6 | Good |
| 4 | 5 | 5 | Poor |
| 5 | 0.5 | 3 | Poor |
| 6 | 10 | 5 | Poor |

For the capacitor of Sample No. 4, a crack was found in the conductive layers. Because the thickness of the conductive layers (the sum of the thicknesses of the first and second conductive layers) was less than twice that of the dielectric layer, the total strength of the capacitor depended relatively highly on the strength of the dielectric layer, and therefore the brittleness of the dielectric layer affected the total strength of the capacitor. For the capacitor of Sample No. 5, a crack was found in the conductive layers because they had a thickness of less than 5 μm and therefore lacked mechanical strength. For the capacitor of Sample No. 6, a crack was found in the dielectric layer because it had a thickness of more than 5 μm and therefore could not withstand the bending. This is because the dielectric ceramic used for the dielectric layer is an inherently brittle material that cannot withstand the bending unless its thickness is sufficiently reduced.

For the capacitors of Sample Nos. 1, 2 and 3, which fall within the scope of the present invention, no crack was found in the dielectric layer or the conductive layers after they were bent at a radius of curvature of 5 mm.

### Second Embodiment

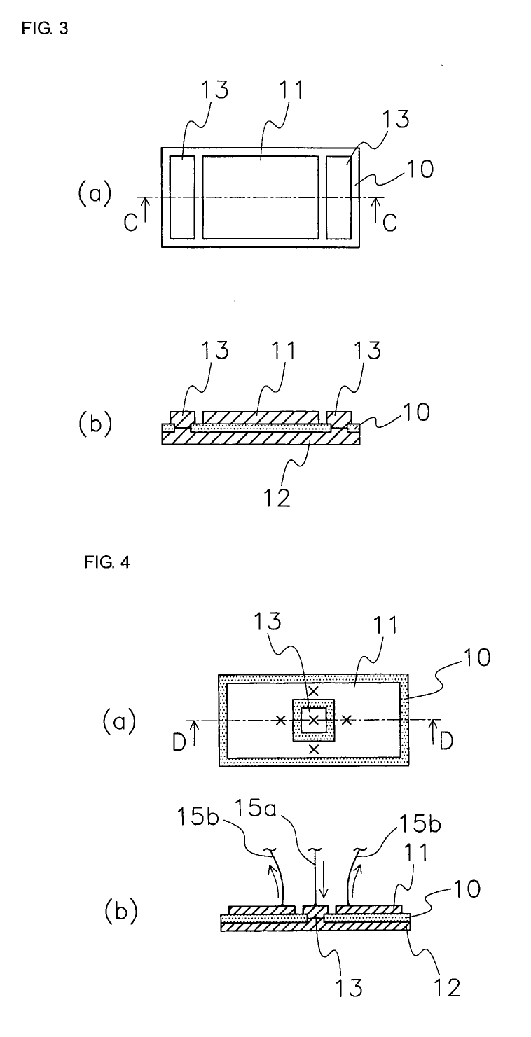

While one first capacitor electrode, one second capacitor electrode, and one lead electrode are formed in the first embodiment, a three-terminal capacitor including two lead electrodes 13, for example, may be formed, as shown in the plan view of FIG. 3(a) and the sectional view of FIG. 3(b) (sectional view taken along line C-C of FIG. 3(a)). In this case, the capacitor of the present invention can be used as a noise filter. In addition, a plurality of first capacitor electrodes and/or a plurality of second capacitor electrodes may be formed.

### Third Embodiment

Next, a third embodiment of the present invention will be described. FIG. 4(a) is a plan view of a capacitor of this embodiment, and FIG. 4(b) is a sectional view taken along line D-D of FIG. 4(a). In this capacitor, the lead electrode 13 is disposed in the center of the first capacitor electrode 11 and is surrounded in its entirety by the first capacitor electrode 11.

In FIG. 4(a), the mark “x” indicates the positions where bonding wires 15a and 15b, an example of external connection means, are connected. FIG. 4(b) schematically shows that opposing currents flow through the bonding wires 15a and 15b to generate magnetic fields that cancel each other out, so that inductance can be reduced.

### Fourth Embodiment

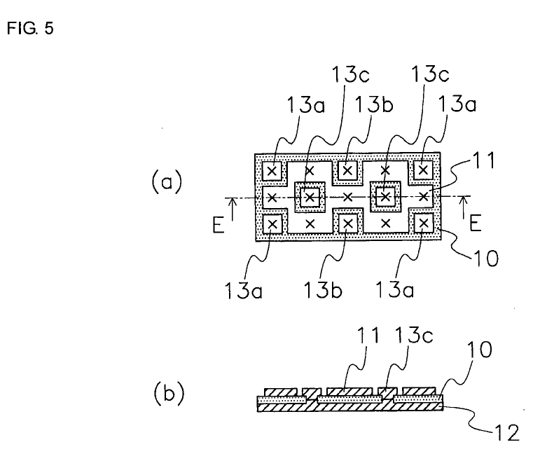

FIG. 5(a) is a plan view of a capacitor of a fourth embodiment, and FIG. 5(b) is a sectional view taken along line E-E of FIG. 5(a). This is a design example including lead electrodes 13a, lead electrodes 13b, and lead electrodes 13c. In FIG. 5(a), the mark “x” indicates the positions where the external connection means are connected, although they are not shown in FIG. 5(b) for illustrative purposes.

Preferably, the lead electrodes 13a, 13b, and 13c are arranged so that they are surrounded by the first capacitor electrode 11 over as large an angle as possible to cause the magnetic fields generated from the external connection means to cancel each other out, thereby reducing the inductance. These lead electrodes 13a, 13b, and 13c, however, do not necessarily have to be surrounded in their entirety.

The lead electrodes 13a are disposed in the corners of the dielectric layer 10 and are surrounded by the first capacitor electrode 11 on the sides opposite the corners over an angle of about 180°. Each of the external connection means connected to the lead electrodes 13a is adjacent to two external connection means connected to the first capacitor electrode 11. The lead electrodes 13b are disposed midway along the sides of the dielectric layer 10 and are surrounded by the first capacitor electrode 11 except for portions facing the sides over an angle of about 270°. Each of the external connection means connected to the lead electrodes 13b is adjacent to three external connection means connected to the first capacitor electrode 11. The lead electrodes 13c are disposed in the center of the first capacitor electrode 11 and are surrounded in their entirety (i.e., over an angle of 360°) by the first capacitor electrode 11. Each of the external connection means connected to the lead electrodes 13c is adjacent to four external connection means connected to the first capacitor electrode 11.

In this capacitor, additionally, the lead electrodes 13a, 13b, and 13c can form separate current paths in the plane of the second capacitor electrode 12 to further reduce the equivalent series inductance of the capacitor.

The portions of the capacitors of FIGS. 3 to 5 which have not been described are similar to those of the capacitor of the first embodiment and therefore have the same operations and advantages as in the first embodiment.

The above embodiment is particularly preferred as a capacitor for use in electronic devices that operate with high-frequency signals since a reduction in the equivalent series inductance of capacitors is becoming more important with the recent trend for higher operating frequencies of electronic devices.

Although bonding wires are shown as an example of the external connection means in the above embodiments, the external connection means used is not particularly limited, and the same operations and advantages can also be achieved using, for example, bumps or via holes.

The first to fourth embodiments described above are merely specific examples illustrative of the present invention, which is of course not limited to these embodiments. For example, modifications can optionally be added to the following points.

(A) Dielectric Layer

The dielectric layer used is preferably a material, such as a ferromagnetic, capable of providing high dielectric constant. For example, metal oxides having a perovskite structure are preferred, including SrTiO₃, (Ba,Sr)TiO₃, and Pb(Zr,Ti)O₃.

(B) Conductive Layer

The conductive layers, which are formed of nickel in the above embodiments, may be formed of a metal other than nickel, such as copper or gold. In addition, a dielectric powder may be added to the conductor ceramic sheets to further enhance the adhesion between the conductive layers and the dielectric layer. In this case, the content of the dielectric powder must be controlled so that the conductive layers have sufficient malleability.

(C) Firing Method

The laminate, which is fired with the firing-supporting green sheets laminated on the outer surfaces of the conductor green sheets in the above embodiments, may be fired without laminating the firing-supporting green sheets.

(D) Binder and Solvent

The binder and solvent contained in the dielectric green sheet and the conductor green sheets are not limited to the examples described above, and appropriate materials may be selected from known materials. In addition, other additives such as an antifoaming agent and a plasticizer may optionally be added.

(E) Filling of Through-Hole

In the above embodiments, the conductor green sheets are laminated on the dielectric green sheet so as to partially cover the through-hole formed therein and are pressed and fired so that the through-hole is filled with the conductor green sheets during the pressing or firing, thereby electrically connecting the first and second conductive layers together. The first and second conductive layers, however, can more reliably be connected together by filling the through-hole with a conductive paste in advance before laminating the conductor green sheets. This method is particularly effective for relatively thick dielectric green sheets.

1. A capacitor comprising:
a dielectric layer;
a first capacitor electrode formed on a first main surface of the dielectric layer;
a second capacitor electrode formed on a second main surface of the dielectric layer; and
a lead electrode formed on the first main surface of the dielectric layer and electrically connected to the second capacitor electrode,
wherein the dielectric layer has a thickness of 5 μm or less,
a sum of thicknesses of the first and second capacitor electrodes is 5 μm or more and at least twice the thickness of the dielectric layer, and
the first and second capacitor electrodes and the lead electrode are formed of a malleable metal.

2. The capacitor according to claim 1, wherein the lead electrode is disposed in a center of the first capacitor electrode and is surrounded in its entirety by the first capacitor electrode.

3. The capacitor according to claim 1, wherein the lead electrode is disposed midway along a side of the dielectric layer and is at least partially surrounded by the first capacitor electrode.

4. The capacitor according to claim 1, wherein the lead electrode is disposed in a corner of the dielectric layer and is at least partially surrounded by the first capacitor electrode.

5. The capacitor according to claim 1, wherein the capacitor includes a plurality of lead electrodes formed on the first main surface of the dielectric layer and electrically connected to the second capacitor electrode.

6. The capacitor according to claim 5, wherein the plurality of lead electrodes are positioned so as to form separate current paths in a plane of the second capacitor electrode.

7. The capacitor according to claim 1, further comprising connection components connected to the lead electrode and the first capacitor electrode.

8. The capacitor according to claim 7, wherein the connection components are bonding wires.

9. The capacitor according to claim 7, wherein the connection components are positioned such that opposing currents flow through the connection components to generate magnetic fields that cancel each other out.

10. A method for producing a capacitor, the method comprising:
preparing a dielectric green sheet containing a dielectric powder and a binder; and having
forming a through-hole in the dielectric green sheet;
preparing conductor green sheets containing a metal powder and a binder;
forming a laminate by laminating the conductor green sheets on two main surfaces of the dielectric green sheet so as to at least partially cover the through-hole;
pressing the laminated sheets together; and
firing the laminate to form the capacitor, the capacitor including a dielectric layer formed from the fired dielectric green sheet, a first conductive layer on a first main surface of the dielectric layer, and a second conductive layer on a second main surface of the dielectric layer, the first and second conductive layers being formed from the fired conductor green sheets and being electrically connected together via the through-hole,
wherein the dielectric green sheet is formed so that the dielectric layer has a thickness of 5 μm or less, and
the conductor green sheets are formed so that a sum of thicknesses of the first and second conductive layers is 5 μm or more and at least twice the thickness of the dielectric layer.

11. The method for producing the capacitor according to claim 10, wherein the dielectric layer and the first and second conductive layers are formed by being simultaneously sintered.

12. The method for producing the capacitor according to claim 10, further comprising:
preparing firing-supporting green sheets; and
laminating the firing-supporting green sheets on the conductor green sheets.

13. The method for producing the capacitor according to claim 12, wherein the firing-supporting green sheets are delaminated when the laminate is fired to form the capacitor.

14. The method for producing the capacitor according to claim 10, wherein
at least part of the second conductive layer is a second capacitor electrode; and
the method further comprises dividing the first conductive layer into a lead electrode electrically connected to the second capacitor electrode via the through-hole and a first capacitor electrode electrically insulated from the second capacitor electrode.

15. The method for producing the capacitor according to claim 10, wherein the conductor green sheets further contain a dielectric powder.

16. The method for producing the capacitor according to claim 10, further comprising filling the through-hole with a conductive paste prior to the step of forming the laminate.
